(19) United States
(12) Patent Application Publication
(10) Pub. No.: US 2018/0216235 A1
(43) Pub. Date: Aug. 2, 2018

(54) AQUEOUS SOLUTION FOR METAL SURFACE TREATMENT, METAL SURFACE TREATMENT METHOD, AND BONDED ARTICLE

(71) Applicant: KABUSHIKI KAISHA KOBE SEIKO SHO (KOBE STEEL, LTD.), Kobe-shi (JP)

(72) Inventors: Yusuke TAKAHASHI, Kobe-shi (JP); Satoru TAKADA, Kobe-shi (JP)

(73) Assignee: KABUSHIKI KAISHA KOBE SEIKO SHO (KOBE STEEL, LTD.), Kobe-shi (JP)

(21) Appl. No.: 15/741,562

(22) PCT Filed: Jun. 28, 2016
(86) PCT No.: PCT/JP2016/069105

§ 371 Date: Jan. 3, 2018

(30) Foreign Application Priority Data
Jul. 9, 2015 (JP) 2015-138050
May 10, 2016 (JP) 2016-094923
Jun. 7, 2016 (JP) 2016-113752

(51) Int. Cl. C23C 22/66; B32B 15/04; B32B 15/20; B32B 7/12

(52) U.S. Cl. CPC C23C 22/66; B32B 7/12; B32B 15/20; B32B 15/043

(57) ABSTRACT

Provided is an aqueous solution for metal surface treatment. The aqueous solution contains a silicate compound in a concentration of 0.001 mass percent to less than 0.5 mass percent, and an organic silane compound in a concentration of 0.001 mass percent to less than 0.5 mass percent. The aqueous solution has a pH of 7 to 14. The aqueous solution for metal surface treatment enables production of a surface-treated metal article by a simplified process, where the surface-treated metal article resists deterioration in bond environment. This can reduce capital investment and production cost.

### TECHNICAL FIELD

The present invention relates to: an aqueous solution and method for metal surface treatment, as well as a bonded article prepared using a metal article treated with the aqueous solution for metal surface treatment.

### BACKGROUND ART

For weight reduction of members or components for use in transportation equipment such as automobiles, ships, and aircraft, attention has been focused on development of techniques of bonding materials with each other, where the materials differ from each other typically in strength, raw materials, and/or mass. In particular, bonding through an adhesive resin (resin adhesive) does not cause corrosion of the materials by electrolytic corrosion and enables bonding of a wide variety of materials without corrosion, and has been actively investigated recently. However, when the resulting bonded article, when placed in a humid environment, undergoes corrosion-degradation at the metal surface due to moisture entering the interface between the metal and the adhesive resin and readily undergoes peeling (separation) at the interface between the metal and the adhesive resin from the corrosion and to maintain bond strength at certain level even in a humid environment.

Known examples of such bonding pretreatment for anticorrosion include surface treatments to provide better corrosion resistance and better paint adhesion of the metal surface.

For example, Patent Literature (PTL)1 describes a technique of treating a metal such as aluminum with an aqueous composition containing a tetraalkyl silicate (such as tetraethyl orthosilicate) and a hydrous oxide sol (such as silica sol), to give higher initial adhesion and better long-term stability in adhesion, of the coating formed on the metal, where the coating layer is exemplified by an adhesive coating.

PTL2 describes a technique of treating a metal substrate with a first treatment solution consisting essentially of at least one multifunctional silane containing at least two trisubstituted silyl groups; and then applying a second coating including a second treatment solution containing at least one organofuctional silane, to provide better corrosion resistance of the metal.

PTL3 describes a technique of treating a metal substrate with a solution containing an aminosilane and a mutli-silyl-functional silane to provide better corrosion resistance of the metal.

PTL4 describes a technique of rinsing the surface of a galvanized steel sheet an aqueous solution containing a silicate compound, and subsequently treating the steel sheet with silane coupling agent, so as to provide better corrosion resistance.

PTL5 describes a technique of applying a solution onto a galvanized steel sheet (steel sheet plated with a zinc-based plating) and drying the coated solution thereby forming a coating so as to provide better paint adhesion and better white rust resistance, where the solution contains a silicic acid ester, an aluminum inorganic salt, and a polyethylene glycol and further contains a silane coupling agent.

PTL6 proposes a technique of treating the surface of a metal material (such as aluminum or an aluminum alloy) with an aqueous solution containing a water glass (such as sodium water glass) and a silane (such as aminosilane) to provide better paint adhesion.

PTL7 describes a technique of treating a metal sheet with an alkaline solution containing an inorganic silicate, an organic functional silane, and a crosslinker containing two or more trialkoxysilyl groups, so as to provide better corrosion resistance and better paint adhesion.

### CITATION LIST

### Patent Literature

PTL1:Japanese Unexamined Patent Application Publication (Translation of PCT Application) No. Hei10(1998)-510307

PTL2: Japanese Patent No. 4376972

PTL3: Japanese Patent No. 4589364

PTL4: U.S. Pat. No. 5,108,793

PTL5: Japanese Patent No. 3289769

PTL6: Japanese Unexamined Patent Application Publication (Translation of PCT Application) No. 2014-502287

PTL7: Japanese Unexamined Patent Application Publication (Translation of PCT Application) No. Hei9(1997)-510259

### SUMMARY OF INVENTION

### Technical Problem

However, the problem resulting article obtained by the technique described in PTL1 has a significantly lower bond strength as a result on a long-term humid degradation test and is not considered to have sufficient bond durability.

The technique described in PTL2 and PTL3 give silane coatings having insufficient bond durability and are also disadvantageous in practical utility in process, because these techniques require high-temperature drying or long-time treatment.

The techniques described in PTL4 and PTL7 are merely intended to contribute to anitcorrosion of metal surface and to better paint adhesion. The formed coatings are therefore thick, but such thick coatings have low mechanical strength, are fragile with respect to tension and stress, and fail to offer high bond strength.

Independently, aluminum alloy materials after surface treatment is coated with an oil for better workability, and then shaped and subjected to bonding through an adhesive. In this process, if an oil is present between the surface treatment layer (surface treatment coating) and the adhesive, causes the adhesive to have significantly lowers adhesion and to fail to give high bond strength, where the oil is exemplified typically by lubricating oils, working oils, press forming oils, and other machine oils. To eliminate or minimize this, demands have been made to develop an aluminum alloy material that resists deterioration in bond durability even when a machine oil such as a working oil or press forming oil is deposited on its surface.

After intensive investigation to solve the problems, the inventors of the present invention previously found a technique as follows. According to this technique, an aluminum alloy substrate is subjected to alkaline degreasing and/or acid wash, is then treated with an alkaline solution containing a silicate compound, and is further treated with an aqueous solution containing a silane coupling agent. The resulting article obtained by the technique resists deterioration in bond strength and offers high bond durability even after exposed to a humid environment with moisture over a long term. On the basis of these findings, the inventors already filed a patent application (Japanese Patent Application No. 2014-228982).

According to this technique, an oxide layer, which is porous and fragile, in the aluminum alloy substrate surface is treated with a basic solution containing a silicate compound, and this allows the oxide layer and silicic acid ion to react with each other to form a complex oxide layer on the substrate surface, where the complex oxide layer is dense, is chemically and physically stable, and has excellent corrosion resistance. Thereafter the article is treated with an aqueous solution containing a silane coupling agent, and this allows the silane coupling agent to bond more firmly to the complex oxide layer, as compared with the case where silane coupling treatment is performed directly on the aluminum natural oxide layer. This protects the silane coupling agent and the aluminum alloy substrate from deterioration by hydration at the bonding interface between them even under a humid condition and offers high bond durability.

Disadvantageously, however, this technique requires separate preparation of the aqueous silicate compound solution and the aqueous silane coupling agent solution and requires separate performing of treatments with the two solutions, and causes high installation cost and high production cost.

Under these circumstances, the present invention has an object to provide an aqueous solution and method for metal surface treatment, each of which enables production of a surface-treated metal article by a simplified process and can contributes to reduction in capital investment and production cost, where the surface-treated metal article resists deterioration in bond strength and offers excellent bond durability even when exposed to a hot and humid environment. The present invention has another object to provide a bonded article obtained using the metal article treated with the aqueous solution for metal surface treatment.

### Solution to Problem

As a result of further investigation with ingenuity, the inventors found that the objects can be achieved by an aqueous solution for metal surface treatment, which contains a silicate compound and an organic silane compound in concentration within specific ranges and has a pH controlled within a specific range. The present invention has been made on the basis of these findings.

Specifically, the present invention provides, in an aspect, an aqueous solution for metal surface treatment. The aqueous solution contains a silicate compound in a concentration of 0.001 mass percent to less than 0.5 mass percent, and an organic silane compound in a concentration of 0.001 mass percent to less than 0.5 mass percent. The aqueous solution has a pH of 7 to 14.

In the aqueous solution for metal surface treatment, the silicate compound is preferably present in a concentration of 0.01 mass percent to less than 0.03 mass percent.

In the aqueous solution for metal surface treatment, the silicate compound is more preferably present in a concentration of 0.015 mass percent to less than 0.2 mass percent.

In the aqueous solution for metal surface treatment, the silicate compound may be a silicate compound represented by the formula: mM₂O nSiO₂, where M is a monovalent cation; m is the number of moles of M₂O; and n is the number of moles of SiO₂, and where the ration (n/m) of n to m may be 1.5 or more.

In the aqueous solution for metal surface treatment, the monovalent cation M may be a sodium ion.

In the aqueous solution for metal surface treatment, the silicate compound may be kanemite.

In the aqueous solution for metal surface treatment, the organic silane compound is preferably present in a concentration of 0.005 mass percent to less than 0.4 mass percent.

In the aqueous solution for metal surface treatment, the organic silane compound is more preferably present in a concentration of 0.01 mass percent to less than 0.3 mass percent.

The aqueous solution for metal surface treatment preferably has a pH of 8 or greater.

In the aqueous solution for metal surface treatment, the organic silane compound may include at least one selected from a silane compound containing hydrolyzable trialkoxysilyl groups in a molecule, a hydrolyzed product of the silane compound, and a polymer derived from the silane compound.

The aqueous solution for metal surface treatment may further include at least one stabilizer selected from the group consisting of C₁-C₄ alcohols and C₁-C₄ carboxylic acids.

In the aqueous solution for metal surface treatment, the organic silane compound may include at least one selected from a silane coupling agent containing a reactive functional group capable of chemically bonding with an organic resin component, a hydrolyzed product of the silane coupling agent, and a polymer derived from the silane coupling agent.

The present invention also provides, in another aspect, a method for metal surface treatment with the aqueous solution for metal surface treatment. The method includes applying the aqueous solution to a surface of a metal to give a surface treatment layer so that the surface treatment layer after drying is present in an amount (mass of coating) of (0.5mg/m² to 35mg/m².

In the method for metal surface treatment, the metal may be an aluminum alloy.

The present invention also provides, in yet another aspect, a bonded article including metal articles treated with the aqueous solution for metal surface treatment, and an adhesive resin through which the metal articles bond with each other.

In addition and advantageously, the present invention provides a bonded article including a metal article treated with the aqueous solution for metal surface treatment; a resin molded article; and an adhesive resin through which the metal article and the resin molded article bond with each other.

### Advantageous Effects of Invention

The aqueous solution and method for metal surface treatment according to the present invention enable production of a surface-treated metal article through a simplified process, where the surface-treated metal article resists deterioration in bond strength and offers excellent bond durability even when exposed to a hot and humid environment. Thus, the aqueous solution and the method contribute to reduction in capital investment and production cost.

### BRIEF DESCRIPTION OF DRAWINGS

FIG. 1A is a side view of a bonded test sample and illustrates how to measure a cohesive failure rate; and

FIG. 1B is a plan view of the bonded test sample and illustrates how to measure the cohesive failure rate.

### DESCRIPTION OF EMBODIMENTS

### Aqueous Solution for Metal Surface Treatment

The aqueous solution for metal surface treatment to the present invention will be described below. Hereinafter this aqueous solution is also referred to as a “surface treatment solution”. In the present description, a percentage based on mass (mass percent) is the same as a percentage based on weight (weight percent).

The aqueous solution for metal surface treatment according to the present invention includes a silicate compound in a concentration of 0.001 mass percent to less than 0.5 mass percent and an organic silane compound in a concentration of 0.001 mass percent to less than 0.5 mass percent, and has a pH of 7 to 14. When the surface treatment solution according to the present invention is applied onto at least part of a metal surface, the silicate compound is introduced into the metal surface to from a complex oxide layer of silicon and the metal element in the metal. In a subsequent drying step, a surface treatment layer including the organic silane compound is formed, while the organic silane compound chemically bonds with the complex oxide layer. The surface-treated metal article obtained in the above manner extremely excels not only in bonding ability with (affinity for) the adhesive, but also in corrosion resistance, resists deterioration in bond strength, and offers excellent bond durability even when exposed to a hot and humid environment. The aqueous solution for metal surface treatment according to the present invention enables a surface treatment with the silicate compound and a surface treatment with the organic silane compound in one step, and enables production of a surface-treated metal article through a amplified process, where the surface-treated metal article offers excellent bond durability. This contributes to reduction in capital investment and production cost.

The surface treatment solution according to the present invention has a pH of 7 to 14. The surface treatment solution, if having a pH greater than 14, disadvantageously causes the organic silane compound to tend to polymerize and has lower storage stability. In addition, the organic silane compound, if undergoing proceeding of polymerization, forms organic silane treatment layer having a larger thickness. Such thick treatment layer may internally fracture when it receives stress, and fails to give high bond strength. In contrast, the surface treatment solution, if having a pH less than 7, causes the silicate compound to precipitate. The precipitated silicate compound forms a thick coating layer as with the polymerized organic silane compound, and this causes the resulting article to have lower bond strength due to peeling of the thick coating layer. To eliminate or minimize these, the pH of the surface treatment solution should be controlled within the range of 7 to 14. The pH of the surface treatment solution is preferably 8 or greater, and more preferably 9 or greater, in consideration of reactivity with the metal oxide layer. The pH of the surface treatment solution can be adjusted as appropriate typically by adding a base or an acid to the solution. The base is exemplified typically by sodium hydroxide, sodium carbonate, and ammonia; and the acid is exemplified typically by acetic acid.

The surface treatment solution contains the silicate compound in a concentration of 0.001 mass percent to less than 0.5 mass percent. The surface treatment solution, if containing the silicate compound in a concentration of 0.5 mass percent or more, forms a surface treatment that has an excessively large thickness and thereby has lower strength. In contrast, the surface treatment solution, if containing the silicate compound in a concentration less than 0.001 mass percent, fails to form a complex oxide layer of silicon and the metal element in the metal due to such excessively low silicate compound concentration, and fails to offer sufficient bond durability. The concentration of the silicate compound in the surface treatment solution is preferably 0.01 mass percent or more, and more preferably 0.015 mass percent or more; and is preferably less than 0.3 mass percent, and more preferably less than 0.2 mass percent.

The surface treatment solution contains the organic silane compound in a concentration of 0.001 mass percent to less than 0.5 mass percent. The surface treatment solution, if containing the organic silane compound in a concentration of 0.5 mass percent or more, forms a surface treatment layer that has an excessively large thickness and thereby has lower strength. In addition, this surface treatment solution disadvantageously has lower stability. In contrast, the surface treatment solution, if containing the organic silane compound in a concentration less than 0.001 mass percent, fails to sufficiently from a surface treatment layer containing the organic silane compound, due to the excessively low organic silane compound concentration, and fails to offer sufficient bond durability. The concentration of the organic silane compound in the surface treatment solution is preferably 0.005 mass percent or more, and more preferably 0.01 mass percent or more; and is preferably less than 0.4 mass percent, and more preferably less than 0.3 mass percent.

The silicate compound contained in the surface treatment solution according to the present invention is not limited in its type. However, in consideration of water solubility of the silicate compound, typical examples of the silicate compound include silicate compounds of a monovalent cation (M), of which representatives are crystalline or noncrystalline (amorphous) silicate compounds which may be represented by mM₂O nSiO₂, where m is the number of moles of M₂O, and n is the number of moles of SiO₂. Such silicate compounds may be indicated hereinafter by the mole ratio (n/m) of n to m. The monovalent cation M is preferably selected from alkali metal ions such as lithium ion, sodium ion, and potassium ion; and ammonium ion. Among them, the monovalent cation M is particularly preferably a sodium ion from the viewpoint of economic efficiency.

Non-limiting examples of the silicate compounds represented by mM₂O nSiO₂ include sodium orthosilicate (having a ratio n/m of about 0.5), sodium metasilicate (having a ratio n/m of about 1), water glass (Nos. 1,2, and 3 as prescribed in Japanese Industrial Standards (JIS); having a ratio n/m of about 1.5 to about 4), and kanemite (having a ratio n/m of about 1.5 to about 3).

Among them, preferred are silicate compounds having a ratio n/m of 1.5 or more, for providing good bond durability. The surface treatment solution, if containing a silicate compound having a ratio n/m of less than 1.5, tends to form a coating layer that has somewhat lower corrosion resistance, and this may cause the resulting article to have lower bond durability, where the coating layer is formed by the reaction between the aluminum oxide layer and the aqueous solution containing the silicate compound and the organic silane compound. The ratio n/m is not limited in its upper limit, but is preferably 4 or less in consideration of production of the silicate compound. Specifically, non-limiting examples of the silicate compound include crystalline layered sodium silicates and water glass. In particular, crystalline layered silicate compounds, such as kanemite, have high ion exchange capacity, form small amounts of reaction products with minerals, less gives deposits on the apparatus and container, and are particularly preferred from the viewpoint of stabilization of operation.

The organic silane compound contained in the surface treatment solution according to the present invention is not limited in its type, but may include at least one of a silane compound containing hydrolyzable trialkoxy groups in a molecule, a hydrolyzed product of the silane compound, and a polymer derived from the silane compound. The silane compound containing hydrolyzable trialkoxy groups in a molecule not only forms dense siloxane bonds by self-polymerization, but also has high reactivity with a metal oxide to form a chemically stable bonds, and allows the resulting coating layer to have still better humid durability. In addition, the organic silane treatment layer has high solubility (compatibility) mutually with organic compounds such as working oils; press forming oils and other machine oils; and adhesives. The coating layer, even when working oils, press forming oils, and other machine oils are deposited thereon, can mitigate the influence of the oils and plays a role of eliminating or minimizing deterioration in bond durability caused by such oil application. The silane compound is not limited in its type, but preferably selected from silane compounds containing two hydrolyzable trialkoxysilyl groups in a molecule (bissilane compounds), from the viewpoint of economic efficiency. Non-limiting examples of such bissilane compounds for use herein include bis(trialkoxysilyl)ethanes, bis(trialkoxysilyl)benzenes, bis(trialkoxysilyl)hexanes, bis(trialkoxysilylpropyl)amines, and bis(trialkoxysilylpropyl)tetrasulfides. In particular, bis(triethoxysilyl)ethane (hereinafter also referred to as BTSE) is preferred from the viewpoints of versatility and economic efficiency. The surface treatment solution may contain each of different organic silane compounds alone or in combination.

The organic silane compound may include at least one of a silane coupling agent containing a reactive functional group capable of chemically bonding with an organic resin component; a hydrolyzed product of the silane coupling agent; and a polymer derived from the silane coupling agent. For example, the use of a silane coupling agent containing a reactive functional group alone or in combination with the silane compound enables formation of chemical bonds between the coating layer and the resin to offer still better bond durability, where non-limiting examples of the reactive functional group include amino group, epoxy group, methacrylic group, vinyl group, and mercapto group. The functional group of the silane coupling agent is not limited to those listed above, and a silane coupling agent containing any of various functional groups can be selected and used as appropriate according to the adhesive resin to be used. Preferred, but non-limiting examples of the silane coupling agent include 3-aminopropyltrimethoxysilane, 3-aminopropyltriethoxysilane, 3-(N-aminoethyl)-aminopropyltrimethoxysilane, 3-(N-aminoethyl)-aminopropyltriethoxysilane, 3-mercaptopropyltrimethoxysilane, 3-glycidoxypropyltriethoxysilane, 3-methacryloxypropyltrimethoxysilane, and 3-methacryloxypropyltriethoxysilane. The surface treatment solution may contain each of different silane coupling agents alone or combination.

When desired, the surface treatment solution may further include one or more other components, such as stabilizers and auxiliaries, than the silicate compounds and the organic silane compounds. For example, the surface treatment solution may contain, as the stabilizer, an organic compound which is exemplified typically by C₁-C₄ carboxylic acids such as formic acid and acetic acid; and C₁-C₄ alcohols such as methanol and ethanol.

A method for preparing the surface treatment solution is exemplified by, but not limited to, the following preparation method.

Initially, an organic silane compound and a small amount of acetic acid as a catalyst are added to a mixture of water and an alcohol such as ethanol to allow the organic silane compound to be thoroughly hydrolyzed, and yields an aqueous organic silane compound solution. Next, the aqueous organic silane compound solution is added to an aqueous solution of a silicate compound in a predetermined concentration, and thereby yields the surface treatment solution.

The aqueous mixed solution of the organic silane compound and the silicate compound is stable at a pH in the basic region, but tends to be polymerized at a pH adjacent to the neutral region. In consideration of this and for stabilization of the solution, the solution is preferably prepared by adding the aqueous organic silane compound solution, which is acidic, gradually to the aqueous silicate compound solution, which is basic, so as to prevent the resulting solution from having a pH adjacent to the neutral region.

The surface treatment solution according to the present invention is not limited in its use, but is advantageously usable for providing better bond durability of various metal materials bearing an oxide layer, including materials of metals such as aluminum, copper, iron and steels, and titanium.

In particular, the surface treatment solution according to the present invention is advantageously usable for allowing aluminum alloys to have better bond durability.

The aluminum alloy for use herein is not limited in its type and may be selected as appropriate according to the intended use of the member into which the aluminum alloy materials processed, and may be selected from various non-heat-treatment or heat-treatment type aluminum alloys prescribed in, or according approximately to, JIS standards. Non-limiting examples of the non-heat-treatment type aluminum alloys include pure aluminum (1xxx-series), Al-Mn alloys (3xxx-series) Al-Si alloys (4xxx-series), and Al-Mg alloys (5xxx-series). Non-limiting examples of the heat-treatment type aluminum alloys include Al-Cu-Mg alloys (2xxx-series), Al-Mg-Si alloys (6xxx-series), and Al-Zn-Mg alloys (7xxx-series).

For example, assume that an aluminum alloy material treated with the surface treatment solution according to the present invention is used for an automobile member. In this case, the aluminum alloy material preferably has a 0.2% yield strength of 100 MPa or more, from the viewpoint of providing sufficient strength. Non-limiting examples of aluminum alloys that can form substrates satisfactorily having the property (sufficient strength) include those containing a relatively large amount of magnesium, such as 2xxx-series, 5xxx-series, 6xxx-series, and 7xxx-series aluminum alloys. These alloys may be subjected to heat treatment (temper) as needed. Of such various aluminum alloys, 6xxx-series aluminum alloys are preferably employed, because these aluminum alloys have excellent age hardenability, require relatively smaller amounts of alloy elements, give scrap capable of recycling with good recycability, and have excellent formability.

The aluminum alloy material to be treated with the surface treatment solution according to the present invention is preferably an aluminum alloy having an oxide layer in at least part of its surface, where the oxide layer contains Mg in a content form 0.1 atomic percent to less than 30 atomic percent and has a Cu content controlled to less than 0.6 atomic percent.

Such aluminum alloy generally contains magnesium as an alloy element. When the oxide layer, which is a complex oxide of aluminum and magnesium, is formed on the surface of the aluminum alloy, a magnesium oxide layer is present as enriched in the surface. The work as intact in this state has such an excessively thick magnesium oxide layer and thereby causes the surface treatment layer (surface treatment coating) to contain a large amount of magnesium, even when the work undergoes the treatment with the surface treatment solution according to the present invention. The resulting surface treatment layer formed in this manner may fail to have sufficient strength as the coating layer itself and may have lower initial adhesiveness.

In addition, the Mg-enriched oxide layer also causes hydration at the interlace with the adhesive resin layer and corrosion of the substrate in a hot and humid environment from which moisture, oxygen, chloride ions, and any other substances may enter the material. This causes the aluminum alloy after the surface treatment to have lower bond durability. Specifically, the oxide layer, if containing Mg in a content of 30 atomic percent or more, tends to cause the aluminum alloy after the surface treatment to have lower adhesiveness and lower bond durability.

To eliminate or minimize these, the oxide layer of the aluminum alloy preferably has a Mg content less than 30 atomic percent. This allows the resulting article to have higher initial adhesiveness and better bond durability. The Mg content in the oxide layer of the aluminum alloy is more preferably less than 25 atomic percent, furthermore preferably less than 20 atomic percent; and particularly preferably less than 10 atomic percent; from the viewpoints of providing higher initial adhesiveness and better bond durability. In contrast the Mg content in the oxide layer of the aluminum alloy is, in terms of lower limit, preferably 0.1 atomic percent or more from the viewpoint of economic efficiency.

The presence of excessive Cu in the surface of the oxide layer causes the surface treatment layer to contain an excessive amount of Cu and thereby causes the article to have lower bond durability, where the surface treatment layer is formed by the surface treatment with the surface treatment solution according to the present invention. To eliminate or minimize this, the Cu content in the oxide film of the aluminum alloy is preferably controlled to less than 0.6 atomic percent, and more preferably controlled to less than 0.5 atomic percent.

The Mg content and the Cu content in the oxide layer of the aluminum alloy can be adjusted or controlled typically by appropriately controlling various conditions in an etching treatment such as acid wash and/or alkali wash, where the conditions are exemplified typically by treatment time, treatment temperature, and concentration and pH of the agent liquid. The Mg content and the Cu content in the oxide layer of the aluminum alloy can be measured by glow discharge-optical emission spectroscopy (GD-OES).

### Metal Surface Treatment Method

Next, the method for metal surface treatment with the aqueous solution for metal surface treatment according to the present invention will be described.

The method for metal surface treatment with the aqueous solution for metal surface treatment according to the present invention includes applying the aqueous solution onto a surface of a metal to form a surface treatment layer so that the surface treatment layer after drying is present in an amount (mass of coating) of 0.5 mg/m² to 35 mg/m². The surface treatment solution may be applied partially or entirely onto the metal surface.

The surface treatment solution maybe applied by a technique such as immersion treatment, spraying, roll coating, bar coating, or electrostatic coating. After the surface treatment, raising may be performed, or not, but is preferably not performed, for effectively providing satisfactory stability and density of the coating layer. Non-limiting examples of the cleaning liquid for use in rinsing include water and alcohols.

The surface treatment solution after application may be dried by heating as needed. The heating is performed at a temperature of preferably 70° C. or higher, more preferably 80° C. or higher, and furthermore preferably 90° C. or higher. The heating is performed at a temperature of preferably 200° C. or lower, more preferably 190° C. or lower, and furthermore preferably 180° C. or lower, because heating at an excessively high temperature may affect, the properties of the metal. The drying (by heating) is performed for a time of preferably 2 seconds or longer, more preferably 5 seconds or longer, and furthermore preferably 10 seconds or longer, while the drying time may vary depending on the heating temperature. In contrast, the drying may be performed for a time of preferably 20 minutes or shorter, more preferably 5 minutes or shorter, and furthermore preferably 2 minutes or shorter.

For sufficiently effectively providing better bond durability, the mass of coating of the surface treatment solution is preferably adjusted so that the coating layer after drying is present in an amount of 1 mg/m² to 20 mg/m²; and is more preferably adjusted so that the coating layer after drying is present in an amount of 1.5 mg/m² to 12 mg/m². The surface treatment solution, if applied in an excessively small mass of coating, may fail to form a coating layer and fail to provide good bond durability. The surface treatment solution, if applied in an excessively large mass of coating may form an excessively thick surface treatment layer and may cause the article to suffer from deterioration in bond durability due to peeling or separation inside the surface treatment layer. In addition, assume that such excessively thick surface treatment layer is subjected typically to a degreasing-etching step for painting after an automobile assembly step. In this case, the surface treatment layer is hardly removed by the step and may thereby adversely affect paint adhesion.

The metal to be subjected to the treatment with the surface treatment solution according to the present invention is preferably subjected to etching treatment as a pretreatment. This is preferred for surely providing uniformity in the treatment.

In the etching treatment, at least one of a treatment with an acidic solution (acid wash) and a treatment with an alkaline solution (alkali wash, alkaline degreasing) is performed partially or entirely on the surface of the metal. An agent liquid for use in acid wash (add wash agent) may be selected typically from, but not limited to, solutions containing at least one selected from the group consisting of sulfuric acid, nitric acid, and hydrofluoric acid. The acid wash agent may contain a surfactant to offer higher degreasing ability. Conditions for the acid wash can be set as appropriate in consideration typically of the chemical composition of the metal material and the thickness of the oxide layer, and are not limited. For example, the acid wash may be performed at a pH of 2 or lower and a treatment temperature of 10° C. to 80° C. for a treatment time of 1 to 120 seconds.

An agent liquid for use in the alkali wash (alkaline degreasing) is also not limited but may be selected typically from solutions containing at least one selected from the group consisting of sodium hydroxide and potassium hydroxide. Conditions for the treatment with the alkaline solution can be set as appropriate in consideration typically of the chemical composition of the metal material and the thickness of the oxide layer, and are not limited. For example, the alkali wash may be performed at a pH of 10 or greater and a treatment temperature of 10° C. to 80° C. for a treatment time of 1 to 120 seconds.

After washing with each agent liquid, rinsing is preferably performed. The rinsing may be performed typically, but non-limitingly, by spraying or immersion. Non-limiting examples of a cleaning liquid for use in the rinsing include industrial water, pure water, and ion-exchanged water.

### Bonded Article Including Surface-Treated Metal Article

The metal article surface-treated with the aqueous solution for metal surface treatment according to the present invention is hereinafter also referred to as a “surface-treated metal article”. The surface-treated metal article resists deterioration in bond strength and oilers excellent bond durability even when exposed to a hot and humid environment. The surface-treated metal article may be bonded to another member (another article) through an adhesive resin to form a bonded article. The category of the other member includes, for example, other surface-treated metal articles; other metal articles without surface treatment; and resin molded articles.

The adhesive resin is not limited and may be selected from adhesive resins conventionally used for bonding of aluminum alloy materials, such as epoxy resins, urethane resins, nitrile resins, nylon resins, and acrylic resins. The layer of the adhesive resin may have a thickness of preferably, but non-limitingly, 10 to 500 μm, and more preferably 50 to 400 μm. This range is preferred for providing higher bond strength.

The other metal articles without surface treatment may be made from metal materials as with the metal materials from which metal articles are made and subjected to a surface treatment.

Non-limiting examples of the resin molded article for use herein include fiber-reinforced plastic molded articles made from various fiber-reinforced plastics, such as glass fiber-reinforced plastics (GFRPs), carbon fiber-reinforced plastics (CFRPs), boron fiber-reinforced plastics (BFRPs), aramid fiber-reinforced plastics (AFRPs, KFRPs), polyethylene fiber-reinforced plastics (such as DFRPs), and ZYLON-reinforced plastics ZFRPs). The use of any of these fiber-reinforced plastic molded articles enables weight reduction of the bonded article while maintaining its strength at certain level.

Other than the fiber-reinforced plastics, the resin molded article may also be made from non-fiber-reinforced engineering plastics such as polypropylenes (PPs), acrylonitrile-butadiene-styrene copolymer (ABS) resins, polyurethanes (PUs), polyethylenes (PEs), poly(vinyl chloride)s (PVCs), nylon 6, nylon 66, polystyrenes (PSs), poly(ethylene terephthalate)s (PETs), polyamides (PAs), poly(phenylene sulfide)s (PPSs), poly(butylene terephthalate)s (PBTs), and polyphthalamides (PPAs).

### Bonded Article Production Method

A method, in particular bonding method, for producing the bonded article may employ any conventional, known bonding methods. A layer of the adhesive resin may be formed on the aluminum alloy material typically, but non-limitingly, by using an adhesive sheet previously prepared from the adhesive resin, or by spraying or applying the adhesive resin onto the surface treatment layer.

Assume that the bonded article according to the embodiment of the present invention employs an aluminum alloy material including two surface treatment layers as both surface layers there of. In this case (not shown), the bonded article can further include the above-mentioned aluminum alloy material, or another aluminum alloy material not bearing the surface-treatment layer, or a resin molded article, as bonded through the adhesive resin or a layer of the adhesive resin to the surface treatment layer.

The produced aluminum alloy material may be coated with a machine oil such as a press forming oil before the preparation of the bonded article, or before processing into an automobile member. The press forming oil for use herein is mainly selected from ones containing an ester component. The technique and conditions to coat the aluminum alloy material with the press forming oil are not limited, and may be selected from a wide variety of techniques and conditions for general coating with a press forming oil. For example, the coating may be performed by immersing the aluminum alloy material in a press forming oil containing ethyl oleate as the ester component. The ester component for use herein is not limited to ethyl oleate, but may also be selected from various ester components such as butyl stearate and sorbitan monostearate.

The bonded article may also be coated with a press forming oil before processing into an automobile member, as with the aluminum alloy material.

### EXAMPLES

The present invention will be described in further detail below on advantageous effects thereof, with reference to several experimental examples indicating examples according to the present invention and comparative examples.

In the experimental examples, metal surfaces treated, and properties such as bond durability were evaluated by methods under conditions as mentioned below.

### EXAMPLE 1

An aluminum alloy cold-rolled sheet having a thickness of 1 mm was prepared using a 6xxx-series aluminum alloy according to JIS 6016 (0.54 mass percent Mg; 1.11 mass percent Si; and 0.14 mass percent Cu). The cold-rolled sheet was cut to a piece having a length of 100 mm and a width of 25 mm and used as a substrate. The substrate was heated as a heat treatment up to an attained temperature of the substrate of 550° C. followed by cooling.

Next, the substrate was subjected to alkaline degreasing with an aqueous solution containing potassium hydroxide and having a pH of 13, at 50° C. for 40 seconds, further subjected to acid wash with a solution containing sulfuric add and hydrofluoric acid and having a pH of 1, at a temperature of 50° C. for a treatment time of 40 seconds, followed by rinsing and drying.

Aside from this, another solution was prepared by mixing 1.0 g of bis(triethoxysilyl)ethane (BTSE) as an organic silane compound with 2.0 g of ethanol 0.001 g of acetic acid, and 1 g of water, followed by stirring. Next, the resulting solution was further diluted with water up to 10 mL and yielded an aqueous BTSE solution having a BTSE concentration of 10 mass percent. Next, 0.4 mL of the aqueous BTSE solution was added to an aqueous solution containing 0.008 g of a crystalline layered silicate compound kanemite (trade name: PURIFEED, supplied by Tokuyama Siltech Co., Ltd., having a mole ratio of SiO₂ to Na₂O of about 2), the resting mixture was further diluted with water up to 100 mL, and yielded an aqueous silicate compound-BTSE mixed solution (surface treatment solution). The resulting surface treatment solution contained kanemite in a concentration of 0.008 mass percent and BTSE in a concentration of 0.04 mass percent. The surface treatment solution had a pH of 10.5.

Then 100 μL of surface treatment solution were applied uniformly onto the substrate using a bar coater, dried by heating at 100° C. for 1 minute, and yielded a surface-treated article.

Next, a press forming oil was diluted with toluene to adjust the concentration, applied onto the surface-treated article, and dried so as to be present in a mass of coating of 1 g/m² after drying.

### EXAMPLE 2

A surface-treated article according to Example 2 was prepared by a procedure similar to that in Example 1, except for using a surface-treatment solution containing kanemite in a concentration of 0.4 mass percent and BTSE in a concentration of 0.003 mass percent. The surface treatment solution had a pH of 12.5. Next, a press forming oil was diluted with toluene to adjust the concentration, applied onto the surface-treated article, and dried so as to be present in a mass of coating of 1 g/m² after drying.

### EXAMPLE 3

A surface-treated article according to Example 3 was prepared by a procedure similar to that in Example 1, except for using a surface treatment solution containing kanemite in a concentration of 0.25 mass percent and BTSE in a concentration of 0.01 mass percent. The surface treatment solution had a pH of 12.2. Next, a press forming oil was diluted with toluene to adjust the concentration, applied onto the surface-treated article, and dried so as to be present in a mass of coating of 1 g/m² after drying.

### EXAMPLE 4

A surface-treated article according to Example 4 was prepared by a procedure similar to that in Example 1, except for using a surface treatment solution containing kanemite in a concentration of 0.12 mass percent and BTSE in a concentration of 0.35 mass percent. The surface treatment solution had a pH of 11.2. Next, a press forming oil was diluted with toluene to adjust the concentration, applied onto the surface-treated article, and dried so as to be present in a mass of coating of 1 g/m² after drying.

### EXAMPLE 5

A surface-treated article according to Example 5 was prepared by a procedure similar to that in Example 1, except for using a surface treatment solution containing kanemite in a concentration of 0.02 mass percent and containing, as organic silane compounds, BTSE in a concentration of 0.15 mass percent in combination with 3-glycidoxypropyltriethoxysilane (GPS) in a concentration of 0.05 mass percent. The surface treatment solution had a pH of 11. Next, a press forming oil was diluted with toluene to adjust the concentration, applied onto the surface-treated article, and dried so as to be present in a mass of coating of 1 g/m² after drying.

### EXAMPLE 6

A surface-treated article according to Example 6 was prepared by a procedure similar to that in Example 1, except for using a surface treatment solution containing kanemite in a concentration of 0.15 mass percent and BTSE in a concentration of 0.15 mass percent. The surface treatment solution had a pH of 11.8. Next, a press forming oil was diluted with toluene to adjust the concentration, applied onto the surface-treated article, and dried so as to be present in a mass of a coating of 1 g/m² after drying.

### EXAMPLE 7

A surface-treated article according to Example 7 was prepared by a procedure similar to that in Example 1, except for using a surface treatment solution containing kanemite in a concentration of 0.1 mass percent and containing, as organic silane compounds, BTSE in a concentration of 0.01 mass percent in combination with GPS in a concentration of 0.01 mass percent. The surface treatment solution had a pH of 11.5. Next, a press forming oil was diluted with toluene to adjust the concentration, applied onto the surface-treated article, and dried so as to be present in a mass of coating of 1 g/m² after drying,

### EXAMPLE 8

A surface-treated article according in Example 8 was prepared by a procedure similar to that in Example 1, except for preparing a surface treatment solution containing kanemite in a concentration of 0.012 mass percent and containing, as organic silane compounds, BTSE in a concentration of 0.008 mass percent in combination with APS in a concentration of 0.004 mass percent. The surface treatment solution had a pH of 10.8. Next, a press forming oil was diluted with toluene to adjust the concentration, applied onto the surface-treated article, and dried so as to be present in a mass of coating of 1 g/m² after drying.

### EXAMPLE 9

A surface-treated article according to Example 9 was prepared by a procedure similar to that in Example 1, except for using a surface treatment solution containing kanemite in a concentration of 0.05 mass permit and BTSE in a concentration of 0.25 mass percent. The surface treatment solution had a pH of 10.5. Next, a press forming oil was diluted with toluene to adjust the concentration, applied onto the surface-treated article, and dried so as to be present in a mass of coating of 1 g/m² after drying.

### EXAMPLE 10

A surface-treated article according to Example 10 was prepared by a procedure similar to that in Example 9, except for using a surface treatment solution containing, as an organic silane compound, APS in a concentration of 0.20 mass percent instead of BTSE in a concentration of 0.25 mass percent. The surface treatment solution had a pH of 11.4. Next, a press forming oil was diluted with toluene to adjust the concentration, applied onto the surface-treated article, and dried so as to be present in a mass of coating of 1 g/m² after drying.

### EXAMPLE 11

A surface-treated article according to Example 11 was prepared by a procedure similar to that in Example 1, except for using a surface treatment solution containing kanemite in a concentration of 0.05 mass percent and containing, as an organic silane compound, bis(triethoxysilyl)benzene (BTSB) in a concentration of 0.08 mass percent instead of BTSE. The surface treatment solution had a pH of 11. Next, a press forming oil was diluted with toluene to adjust the concentration, applied onto the surface-treated article, and dried so as to be present in a mass of coating of 1 g/m² after drying.

### EXAMPLE 12

A surface-treated article according to Example 12 was prepared by a procedure similar to that in Example 1, except for using surface treatment solution containing kanemite in a concentration of 0.05 mass percent, containing, as an organic silane compound, bis(triethoxysilylpropyl)tetrasulfide (BTSH) in a concentration of 0.14 mass percent instead of BTSE, and employing a solvent containing 90% ethanol in water. The surface treatment solution had a pH of 11. Next, a press forming oil was diluted with toluene to adjust the concentration, applied onto the surface-treated article, and dried so as to be present in a mass of coating of 1 g/m² after drying.

### EXAMPLE 13

A surface-treated article according to Example 18 was prepared by a procedure similar to that in Example 9, except for using sodium metasilicate (mole ratio of SiO₂ to Na₂O: about 1) instead of kanemite. The surface treatment solution had a pH of 10.7. Next, a press forming oil was diluted with toluene to adjust the concentration, applied onto the surface-treated article, and dried so as to be present in a mass of coating of 1 g/m² after drying.

### EXAMPLE 14

A surface-treated article according to Example 14 was prepared by a procedure similar to that in Example 9, except for using water glass (mole ratio of SiO₂ to Na₂O: 3 to 3.4) instead of kanemite. The surface treatment solution had a pH of 10.2. Next, a press forming oil was diluted with toluene to adjust the concentration, applied onto the surface-treated article, and dried so as to be present in a mass of coating of 1 g/m² after drying.

### COMPARATIVE EXAMPLE 1

A surface-treated article according to Comparative Example 1 was prepared by a procedure similar to that in Example 1, except for using a surface treatment solution containing kanemite in a concentration of 0.61 mass percent and BTSE in a concentration of 0.1 mass percent. The surface treatment solution had a pH of 12.5. Next, a press forming oil was diluted with toluene to adjust the concentration, applied onto the surface-treated article, and dried so as to be present in a mass of coating of 1 g/m² after drying.

### COMPARATIVE EXAMPLE 2

A surface-treated article according to Comparative Example 2 was prepared by a procedure similar to that in Example 1, except for using a surface treatment solution containing kanemite in a concentration of 0.061 mass percent and containing, as organic silane compounds, BTSE in a concentration of 0.2 mass percent in combination with APS in a concentration of 0.8 mass percent. The surface treatment solution had a pH of 12.1. Next, a press forming oil was diluted with toluene to adjust the concentration, applied onto the surface-treated article, and dried so as to be present in a mass of coating of 1 g/m² after drying.

### COMPARATIVE EXAMPLE 3

A surface-treated article according to Comparative Example 3 was prepared by a procedure similar to that in Example 1, except for using a surface treatment solution containing kanemite in a concentration of 0.005 mass percent and BTSE in a concentration of 1 percent. The surface treatment solution had a pH of 9.5. Next, a press forming oil was diluted with toluene to adjust the concentration, applied onto the surface-treated article, and dried so as to be present in a mass of coating of 1 g/m² after drying.

### COMPARATIVE EXAMPLE 4

A surface-treated article according to Comparative Example 4 was prepared by a procedure similar to that in Example 1, except for using a surface treatment solution containing kanemite in a concentration of 0.0061 mass peixsnt and BTSE in a concentration of 0.0009 mass percent. The surface treatment solution had a pH of 10.3. Next, a press forming oil was diluted with toluene to adjust the concentration, applied onto the surface-treated article, and dried so as to be present in a mass of coating of 1 g/m² after drying.

### COMPARATIVE EXAMPLE 5

A surface-treated article according to Comparative Example 5 was prepared by a procedure similar to that in Example 1, except for using a surface treatment solution containing kanemite in a concentration of 0.0009 mass percent and BTSE in a concentration of 0.01 mass percent. The surface treatment solution had a pH of 8.1. Next, a press forming oil was diluted with toluene to adjust the concentration, applied onto the surface-treated article, and dried so as to be present in a mass of coating of 1 g/m² after drying.

### Coating Amount Measurement

The amount of coating (mass of coating) formed rising any of the surface-treatment solutions herein was measured by X-ray fluorescence analysis. Specifically, the silicon content after the coating treatment (treatment with the solution) was measured using X-ray fluorescence, and the intensity of the X-ray fluorescence was converted into the mass of coating using a calibration curve. The results are given in Table 1.

### Cohesive Failure Rate (Bond Durability)

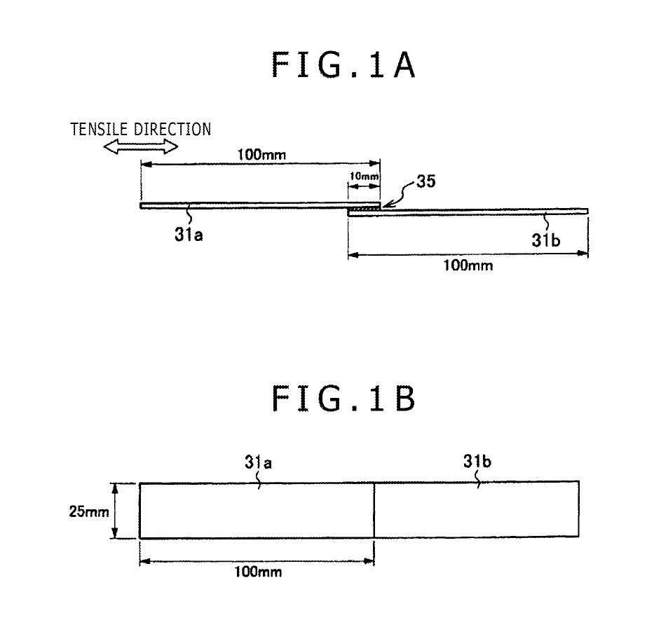

FIGS. 1A and 1B are a side view and a plan view, respectively, of a bonded test sample and schematically illustrate how to measure a cohesive failure rate. As illustrated in FIGS. 1A and 1B, two test samples 31a and 31b (25 mm wide) having the same configuration were partially overlaid on each other at edges with an overlapping length of 10 mm (adhesive area: 25 mm by 10 mm) and bonded to each other using a thermosetting epoxy resin-containing adhesive resin.

The adhesive resin 35 used herein was a thermosetting epoxy resin-containing adhesive resin (containing a bisphenol-A epoxy resin in a content of 40 to 50 mass percent). The adhesive resin 35 was combined with a trace amount of glass beads (having an average particle size of 250 μm) so as to adjust the thickness of the layer of the adhesive resin 35 to 250 μm.

The insulting article was dried at room temperature for 30 minutes after the overlapping, and then heated at 170° C. for 20 minutes to perform thermosetting. The article was then left stand at room temperature for 24 hours and yielded a bonded test sample.

The prepared bonded test sample was held in a hot and humid environment at a temperature of 50° C. and relative humidity of 95% for 30 days, then pulled using a tensile tester at a speed of 50 mm/min., and the cohesive failure rate of the adhesive resin in the bonded portion was evaluated. The cohesive failure rate was calculated according to following Mathematical Expression 1. In Mathematical Expression 1, one of the two test specimens constituting the bonded test sample after pulling was defined as a test specimen “a”; and the other was defined as a test specimen “b”.

[Math 1]

Cohesive failure rate (%)=100 [(Interfacial peeling area of test specimen “a”)/(Bonded area of test specimen “a”)×100+(Interfacial peeling area of test specimen “b”)/(Bonded area of test specimen“b”)×100]

Three bonded test samples were prepared per each test condition, and the average of three measurement was defined as the cohesive failure rate. According to evaluation criteria, a sample having a cohesive failure rate of leas than 60% was evaluated as having poor bond durability (x); a sample having a cohesive failure rate of 60% to less than 70% was evaluated as having somewhat good bend durability (Δ); a sample having a cohesive failure rate of 70% to less than 90% was evaluated as having good bond durability (o); and a sample having a cohesive Mine rate of 90% car more was evaluated as having excellent bond durability (⊚). The results are given in Table 1.

TABLE 1

| | Surface-treatment solution | | | | |
|---|---|---|---|---|---|
| | | Organic silane compound | | | |
| | Silicate | | Coupling | Mass of | |
| | compound | Bissilane | agent | coating | Evalu- |
| | (mass %) | (mass %) | (mass %) | (mg/m²) | ation |
| Example 1 | Kanemite | BTSE | | 1.4 | Δ |
| | (0.008) | (0.04) | | | |
| Example 2 | Kanemite | BTSE | | 21 | Δ |
| | (0.4) | (0.003) | | | |
| Example 3 | Kanemite | BTSE | | 13 | ◯ |
| | (0.25) | (0.01) | | | |
| Example 4 | Kanemite | BTSE | | 13 | ◯ |
| | (0.012) | (0.35) | | | |
| Example 5 | Kanemite | BTSE | GPS | 5.7 | ⊚ |
| | (0.02) | (0.15) | (0.05) | | |
| Example 6 | Kanemite | BTSE | | 11 | ⊚ |
| | (0.15) | (0.15) | | | |
| Example 7 | Kanemite | BTSE | GPS | 4.7 | ⊚ |
| | (0.1) | (0.01) | (0.01) | | |
| Example 8 | Kanemite | BTSE | APS | 1.5 | ◯ |
| | (0.012) | (0.008) | (0.004) | | |
| Example 9 | Kanemite | BTSE | | 7.3 | ⊚ |
| | (0.05) | (0.25) | | | |
| Example 10 | Kanemite | | APS | 6.7 | ◯ |
| | (0.05) | | (0.20) | | |
| Example 11 | Kanemite | BTSB | | 4.5 | ⊚ |
| | (0.05) | (0.08) | | | |
| Example 12 | Kanemite | BTSH | | 6.1 | ⊚ |
| | (0.05) | (0.14) | | | |
| Example 13 | sodium | BTSE | | 7.1 | ◯ |
| | meta- | (0.25) | | | |
| | silicate | | | | |
| | (0.05) | | | | |
| Example 14 | water | BTSE | | 7.5 | ⊚ |
| | glass | (0.25) | | | |
| | (0.05) | | | | |
| Comp. Ex. 1 | Kanemite | BTSE | | 36 | X |
| | (0.61) | (0.1) | | | |
| Comp. Ex. 2 | Kanemite | BTSE | APS | 40 | X |
| | (0.061) | (0.2) | (0.8) | | |
| Comp. Ex. 3 | Kanemite | BTSE | | 36 | X |
| | (0.005) | (1) | | | |
| Comp. Ex. 4 | Kanemite | BTSE | | 0.4 | X |
| | (0.0061) | (0.0009) | | | |
| Comp. Ex. 5 | Kanemite | BTSE | | 0.4 | X |
| | (0.0009) | (0.01) | | | |

The sample according to Comparative Example 1 was treated with the surface treatment solution containing the silicate compound in a concentration higher than the range specified in the present invention, and offered poor bond durability.

The samples according to Comparative Example 2 and Comparative Example 3were treated with the surface treatment solutions each containing the organic silane compound(s) in a concentration higher than the range specified in the present invention, and offered poor bond durability.

The sample according to Comparative Example 4 was treated with the surface treatment solution containing the organic silane compound in a concentration lower than the range specified in the present invention, and offered poor bond disability.

The sample according to Comparative Example 5 was treated with the surface treatment solution containing the silicate compound in a concentration lower than the range specified in the present invention, and offered poor bond durability.

The contrast, the samples according to Examples 1 to 14, which meet the conditions specified in the present invention, offered good bond durability.

The sample according to Example 13 is a sample prepared under conditions approximately the same as those in Example 9, except for using a sodium silicate of a different type. Specifically, sodium metasilicate (mole ratio of SiO₂ to Na₂O: about 1) was used in this sample instead of kanemite (mole ratio of SiO₂ to Na₂O: about 2; PURIFEED, supplied by Tokuyama Siltech Co., Ltd) used in Example 9. The sample according to Example 10, using sodium metasilicate having a mole ratio of SiO₂ to Na₂O of less than 1.5 (about 1), had a cohesive failure rate of 70% to less than 90% at an acceptable level, but had a somewhat lower cohesive failure rate as compared with the sample according to Example 9, using the kanemite having a mole ratio of SiO₂ to Na₂O of about 2.

The sample according to Example 14 is a sample prepared under conditions approximately the same as those in Example 9, except for using a sodium silicate of a different type. Specifically, water glass (mole ratio of SiO₂ to Na₂O: about 3 to 3.4) was used instead of kanemite (mole ratio of SiO₂ to Na₂O: about 2; PURIFEED, supplied by Tokuyama Siltech Co., Ltd.) used in Example 1. The sample according to Example 11, using water glass having a mole ratio of SiO₂ to Na₂O of 1.5 or more (about 3 to about 3.4), had a cohesive failure rate equivalent to that of the sample according to Example 9, using kanemite having a mole ratio of SiO₂ to Na₂O of about 2.

While the present invention has been particularly described in detail with reference to specific embodiments thereof, it is obvious to those skilled in the art that various changes and modifications may be made without departing from the spirit and scope of the present invention.

This application is based on, and claims priority to, Japanese Patent Application No. 2015-138050), filed on Jul. 9, 2015; Japanese Patent Application No. 2016-094923, filed on May 10, 2016; and Japanese Patent Application No. 2016-113752, filed on Jun. 7, 2016, the entire contents of each of which applications are incorporated herein by reference.

1. An aqueous solution, comprising:
a silicate compound in a concentration of 0.001 mass percent to less than 0.5 mass percent; and
an organic silane compound in a concentration of 0.001 mass percent to less than 0.5 mass percent,
the aqueous solution having a pH of 7 to 14.

2. The aqueous solution according to claim 1, wherein the silicate compound is present in a concentration of 0.01 mass percent to less than 0.3 mass percent.

3. The aqueous solution according to claim 1, wherein the silicate compound is present in a concentration of 0.015 mass percent to less than 0.2 mass percent.

4. The aqueous solution according to claim 1, wherein the silicate compound is a silicate compound represented by nM₂O·nSiO₂,
wherein M is a monovalent cation; m is a number of moles of M₂O; and n is a number of moles of SiO₂, and
wherein a ratio n/m of n to m is 1.5 or more.

5. The aqueous solution according in claim 4, wherein M is a sodium ion.

6. The aqueous solution according to claim 5, wherein the silicate compound is kanemite.

7. The aqueous solution according to claim 1, wherein the organic silane compound is present in a concentration of 0.005 mass percent to less than 0.4 mass percent.

8. The aqueous solution according to claim 1, wherein the organic silane compound is present in a concentration of 0.01 mass percent to less than 0.3 mass percent.

9. The aqueous solution according to claim 1, wherein the aqueous solution has a pH of 8 or greater.

10. The aqueous solution according to claim 1,
wherein the organic silane compound comprises at least one selected from:
a silane compound containing a plurality of hydrolyzable trialkoxysilyl groups in a molecule;
a hydrolyzed product of the silane compound; and
a polymer derived from the silane compound.

11. The aqueous solution according to claim 1, further comprising, as a stabilizer, at least one selected from the group consisting of:
C₁-C₄ alcohols; and
C₁-C₄ carboxylic acids.

12. The aqueous solution according to claim 1,
wherein the organic silane compound comprises at least one selected from:
a silane coupling agent containing a reactive functional group capable of chemically bonding with an organic resin component;
a hydrolyzed product of the silane coupling agent; and
a polymer derived from the silane coupling agent.

13. A method for treating a metal surface with the aqueous solution according claim 1, the method comprising
applying the aqueous solution onto a surface of a metal to form a surface treatment layer so that the surface treatment layer after drying is present in an amount of 0.5 mg/m² to 35 mg/m².

14. The method according to claim 13, wherein the metal is an aluminum alloy.

15. A bonded article comprising:
metal articles treated with the aqueous solution according to claim 1; and
an adhesive resin through which the metal articles bond with each other.

16. A bonded article comprising:
a metal article treated with the aqueous solution according to claim 1:
a resin molded article; and
an adhesive resin through which the metal article and the resin molded article bond with each other.
